(19) United States
(12) Patent Application Publication
(10) Pub. No.: US 2012/0066497 A1
(43) Pub. Date: Mar. 15, 2012

(54) METHOD AND DEVICE FOR ENABLING PORTABLE USER REPUTATION

(75) Inventors: Sandeep Shankaran Kumar, Eindhoven (NL); Robert Paul Koster, Eindhoven (NL)

(73) Assignee: KONINKLIJKE PHILIPS ELECTRONICS N.V., EINDHOVEN (NL)

(21) Appl. No.: 13/320,768

(22) PCT Filed: May 11, 2010
(86) PCT No.: PCT/IB2010/052065

§ 371 Date: Nov. 16, 2011

(30) Foreign Application Priority Data
May 20, 2009 (EP) 09160767.1

(51) Int. Cl. H04L 9/32

(52) U.S. Cl. 713/168

(57) ABSTRACT

The present invention relates to a method and a device adapted to determine at a party whether a set comprising at least one user pseudonym is associated with a user, wherein each of the user pseudonyms in the set is associated with the user at a service portal. At the party, for each of the user pseudonyms comprised in the set, a publicly available first coded string associated with the user pseudonym is retrieved from the service portal associated with the user pseudonym, wherein each of the first coded strings has been generated on the basis of a first secret unique to said first coded string. The user's knowledge of the first secrets associated with the respective first coded strings is verified by means of a first cryptographic protocol for interacting with the user, wherein the first protocol is adapted to utilize the first coded strings.

### TECHNICAL FIELD

The present invention generally relates to network-based interactions and transactions between parties. In particular, the present invention relates to a method for verifying whether user pseudonyms used at different service portals belong to the same user.

### BACKGROUND

Networked interactions between parties whose real identities are unknown to each other are becoming increasingly common. Such interactions may comprise exchange of information and/or real value transactions, and typically take place in service portals comprising various service providers, such as eBay (www.ebay.com). Such interactions and/or transactions between two parties require a party to place a certain amount of trust in the other party. Therefore, user reputation based systems are commonly used in service portals, which systems generally function by collecting, aggregating and distributing the historic behavior of the participating parties of a service portal, whereby the reputation of a participating party (e.g. the participating party's trustworthiness) with regards to interactions with the other participating parties within the service portal may be indicated to the other participating parties. This typically works by enabling parties to provide ratings about each other or each other's behavior to a trusted party who will calculate a reputation based on the ratings.

In networked interactions such as have been discussed in the foregoing, users in general employ user pseudonyms, such as already implemented in existing Internet communities and reputation based systems, in order to maintain anonymity.

In general, reputation based systems require that the service portals and user pseudonyms are relatively long-lived, so that there is a user expectation of future interactions taking place, and further that feedback regarding occurring interactions are saved and made visible to the participating parties, and also that past feedback relating to participating parties guides interaction decisions, i.e. decisions of the kind with which party an interaction should be performed. If a particular party's reputation is high, other participating parties may deem it safe to interact with that particular party and accordingly the other participating parties may preferably interact with the particular party rather than with parties having a lower reputation.

Within some service portals, reputation has become an extremely valuable commodity that enables higher price premiums in identical real value transactions. Therefore, participating parties desire and strive toward earning a good reputation within such service portals.

However, reputation may also provide a means for a service portal to “lock up” users at the particular service portal, or in other words, to discourage users from using other service portal's services. This is partially due to that for a user switching to a new service portal, the user in general needs to start building again his or her reputation from the beginning, although the user may already have painstakingly built his or her reputation at another service portal. Also, different service portals cannot in general securely verify if the user pseudonyms used at other service portals actually belong to the same user. This may in principle be at least partially solved by employing a federated identity management system. However, this is generally less desirable as the number of different service portals may be very large. Furthermore, as already indicated above, service portal proprietors realize that the painstakingly built user reputations enable them to lock up users to their service portals, and hence the service portal proprietors would be less willing to participate in a federated identity management system in which they need to share information about their users with their competitors. Moreover, different service portals generally use different reputation system frameworks which may not directly map to each other.

Due to such lock ups, users (e.g. consumers) are hampered in switching to other service portals. Thus, portability of user reputation data built up at different service portals is of great importance to users.

Users, which may typically be end users, but possibly service providers, in general employ different user pseudonyms at different portals where they can engage in transactions and at the same time build up a reputation. These user pseudonyms can be directly linked to a real user if personally identifying information is revealed, such as the user's real name or email-address. However, it is in general not difficult for an impersonator to claim the identity of a user having a high reputation at another service portal by submitting the corresponding personally identifying information, thereby stealing the user's painstakingly built reputation at other service portals. Thus, the revealing of such personally identifying information when exporting, or linking, user reputation to another portal is less desirable.

There is thus a need in the art for improved methods or devices that address the above problems.

### SUMMARY OF THE INVENTION

In view of the above, an object of the present invention is to provide an improved method and device for mitigating or eliminating the above problems.

This and other objects are partially or completely achieved by a method and a device according to the independent claims. Additional embodiments of the present invention are defined in the dependent claims, and further objects of the present invention will become apparent through the following description.

In the context of the present invention, “reputation” of a user for example refers to, but is not limited to, the trustworthiness of the user in performing real-value transactions with other parties involving trading of goods (e.g. a service portal such as eBay), the trustworthiness of the user's contributions at an Internet forum (message board) that the user may participate in and/or be a member of, the trustworthiness of the user's reviews at review web pages, the trustworthiness and commitment of users in their participation in a community or self-help group, the trustworthiness of service providers in providing good service and/or following good business and/or ethical practices, etc.

In the context of the present invention, by the term “user” it is meant not only a user at a service portal (i.e. a consumer), but the term “user” may also refer to a service portal, a transaction party, a service provider, a trusted third party, etc., i.e. a party that may provide or engage in interactions (e.g. real-value transactions) and at the same time build a reputation.

In the context of the present invention, by a “service portal” it is meant an entity that provides services to other entities.

According to a first aspect of the present invention, there is provided a method adapted to determine at a party whether a set comprising at least one user pseudonym is associated with a user, wherein each of the user pseudonyms in the set is associated with the user at a service portal. The method comprises, at the party, for each of the user pseudonyms in the set retrieving from the service portal associated with the user pseudonym a publicly available first coded string associated with the user pseudonym, wherein each of the first coded strings has been generated on the basis of a first secret unique to said first coded string. The method may further comprise verifying that the first secrets associated with the respective first coded strings are known to the user by means of a first cryptographic protocol for interacting with the user, wherein the first protocol is adapted to utilize the first coded strings.

A method according to the first aspect of the present invention enables implementation of a system for assuring or proving to a party that a set of user pseudonyms, each user pseudonym in the set being associated with a particular user at a service portal, belongs to the user. Each of the user pseudonyms may in general be associated with different service portals. Once the party is assured that the user pseudonyms in the set indeed belong to the user, information about the user at the various service portals associated with the user's respective user pseudonym, for example reputation metadata regarding the user's reputation, for example with regards to interaction with other parties at the respective service portal, may be transferred to the party in order to provide information about the user. The party may for example be a trusted third party or meta-reputation server, which may collect information about the user and process or aggregate this information and present the result to another party. This other party may for example be the party that the user is intending to interact with. Alternatively, information may be transferred directly to the party that intends to interact with the user. In this manner, the party may be provided with information about the user that the party is going or intending to interact with, before interaction takes place, which may increase the level of trust in the interaction. Such a system may be managed by the users themselves with no or only a minimal amount of action required to be taken or technical support to be provided by the service portals. The party could for example be a new service portal that the user wishes to use, or another party with which the user intends to interact with, e.g. a new (real value) transaction partner.

According to a second aspect of the present invention, there is provided a device adapted to determine whether a set comprising at least one user pseudonym is associated with a user, wherein each of the user pseudonyms in the set is associated with the user at a service portal. The device according to the second aspect of the present invention comprises a communications unit and processing unit. The communications unit may be adapted to, for each of the user pseudonyms in the set, retrieve from the service portal associated with the user pseudonym a publicly available first coded string associated with the user pseudonym, wherein each of the first coded strings has been generated on the basis of a first secret unique to said first coded string. The processing unit may be adapted to verify that the first secrets associated with the respective first coded strings are known to the user by means of a first cryptographic protocol for interacting with the user, wherein the first protocol is adapted to utilize the first coded strings.

A device according to the second aspect of the present invention may achieve advantages identical or similar to the advantages that may be achieved by the method according to the first aspect of the present invention.

In the context of the present invention, by “publicly available” coded strings it is meant coded strings that may be publicly visible (i.e. readable by a third party) at a service portal, but in general not modifiable by third parties (or the service portal itself) not having the proper credentials. For example, the coded strings may be comprised in a part of a publicly accessible web site of a service provider that displays information on the basis of user input. Such web sites include, but are not limited to, auction and trading web sites, and forums and review web sites.

According to another aspect of the present invention, there is provided a mobile user-identity communications device comprising a memory unit adapted to store data, wherein the mobile user-identity communications device is adapted to be utilized in a method according to an exemplifying embodiment of the present invention, wherein the interaction with the user is performed via the mobile user-identity communications device, and wherein the at least one user pseudonym comprised in the set and at least some of the first secrets and the second secret are stored in the memory unit.

Such a mobile user-identity communications device may for example be a personal device or a shared device provided with authentication means (for example intended to be used within a family of persons). The second secret may be manually set or generated, e.g. on-the-fly, in the user-identity communications device or may be derived for example by using a combination of biometrics of the person that is using the user-identity communications device and device Physical Unclonable Function (PUF). By such a mobile user-identity communications device, the user may have easy access to the information, among other things the first and second secrets, that is required in a method according to an embodiment of the present invention such as has been described in the foregoing, which may facilitate performing the method.

According to yet another aspect of the present invention, there is provided a computer program product adapted to, when executed in a processor unit, perform a method according to the first aspect of the present invention or any embodiment thereof.

According to yet another aspect of the present invention, there is provided a computer-readable storage medium on which there is stored a computer program product adapted to, when executed in a processor unit, perform a method according to the first aspect of the present invention or any embodiment thereof.

According to an exemplifying embodiment of the present invention, for each of the user pseudonyms in the set, a publicly available second coded string associated with the user pseudonym may be retrieved from the service portal, wherein each of the second coded strings has been generated on the basis of a second secret, common to every second coded string. It may then be verified that the second secret associated with each second coded string is known to the user by means of a second cryptographic protocol for interacting with the user, wherein the second protocol is adapted to utilize the second coded strings.

By such a configuration, it may be proved to the party or the party may be assured that the user pseudonyms in the set are not shared with (or bought from) other parties.

In addition to the second coded strings, the second cryptographic protocol may be adapted to utilize the first coded strings. According to an exemplifying embodiment of the present invention, for each of the user pseudonyms in the set of pseudonyms, reputation metadata associated with the user pseudonym may be retrieved at the party from the service portal associated with the user pseudonym. The reputation metadata may be adapted to indicate the service portal's estimation of the user's reputation. If the verification or verifications are successful, a trust metric may be derived on the basis of retrieved reputation metadata, the trust metric being associated with the user and adapted such that the trust metric is indicative of the reputation of the user across service portals.

Such a configuration enables implementation of a reputation system for exporting, or porting, or sharing, user reputation data from one or several service portals to another service portal or a requesting party, e.g. a new transaction partner, or linking user reputation data from one or several service portals with another service portal. Such exporting, porting, sharing and/or linking may be managed by the users themselves with no or only a minimal amount of action required to be taken or technical support to be provided by the service portals. Such a method enables a user to in an easy and straightforward manner claim his or her reputation data at various service portals, which reputation data may have been painstakingly built up over time, and present it to a requesting party. The requesting party may for example be a party with which the user intends to interact with, e.g. a new transaction partner. By the present embodiment of the invention, such reputation data may not only be presented to the requesting party but the association of the reputation data with the particular user may also be assured or proved to the requesting party. Thus, the level of trust in an interaction between the user and the requesting party may be increased, compared with interaction between the user and the requesting party when the reputation of the user with regards to interaction with other parties is unknown to the requesting party. The requesting party may thus derive a trust metric based on the reputation metadata retrieved from service portals at which the user have had previous experiences in interacting with other parties, for example by aggregating the reputation metadata of the user that the requesting party intends to interact with. The requesting party may also for example be a new service portal that allows new users to take into account their local reputation data from other service portals when starting to use the new service portal, thereby reducing the inconvenience and/or avoiding the disadvantages of having to start off as a party having an unknown reputation.

Typically, reputation metadata may be available (preferably publicly) at a service portal, such as reputation metadata of an eBay user. Preferably, the reputation metadata is visible at the service portal in such a manner that the reputation metadata may be considered to be uniquely linked, or associated, with the respective user pseudonym. The service portal may be adapted for this purpose.

A service portal may be adapted such that the link between the user pseudonyms, the reputation metadata associated therewith, and the coded strings is publicly available at the service portal.

According to still another aspect of the present invention, there is provided a trust management system adapted to manage reputation data for at least one user from one or several service portals. The trust management system may comprise a device in accordance with the exemplifying embodiment of the present invention described immediately above. The device may be adapted to make information based on the trust metric available to a party.

According to another exemplifying embodiment of the present invention, it may be individually verified that each of the first secrets associated with the respective first coded strings is known to the user.

By such a configuration, the security of the process of determining whether the set of user pseudonyms is associated with a user at the party may be further increased, as the user's knowledge of each of the first secrets is tested one at a time.

According to yet another exemplifying embodiment of the present invention, it may be verified that a result of a cryptographic operation performed on the first secrets associated with the respective first coded strings is known to the user.

For example, the operation performed on the first secrets associated with the respective first coded strings may comprise summing the first secrets, wherein it may be verified that the sum of the first secrets is known to the user.

By such a configuration, the speed of the process of determining whether the set of user pseudonyms is associated with a user at the party may be increased, as the number of message transfers between the user and the party may be decreased. For example, this enables implementation of a reputation system, as has been described in the foregoing, having an improved efficiency with regards to speed of operation. For instance, this may in turn enable implementation of a trust management system between parties in such a way that the system has an improved latency.

According to yet another exemplifying embodiment of the present invention, the second secret may comprise a composite number.

In the context of the present invention, by the term “a composite number” it is meant a positive integer that has a positive divisor other than one or the positive integer itself. Every composite number may be written as the product of two or more (not necessarily distinct) prime numbers. In this manner, a group of users (e.g. within a family) may collectively be associated with at least some of the user pseudonyms in the set if the users in the group also know the first secrets associated with the respective first coded strings.

According to yet another exemplifying embodiment of the present invention, the first protocol may be based on a Diffie-Hellman protocol adapted to verify that the first secrets associated with the respective first coded strings are known to the user.

In this manner, there is provided a first protocol providing a security roughly on the same level as an RSA algorithm, i.e. a relatively high security. In this way, the degree of security of the first protocol is in principle limited only by the access to (very) large prime numbers.

According to yet another exemplifying embodiment of the present invention, at least one of the coded strings may be adapted such that the at least one of the coded strings is modifiable at the respective service portal only by the user.

In other words, a coded string may be inserted at a location at the respective service portal such that only a user having the proper credentials may edit the coded string. Such a configuration enables that no global authentication method is required to prove access to the user profile, or user account, such as in a federated identity management system.

In the context of the present invention, by the term “federated identity management system” it is meant an identity management system in which the user accounts of a user for all of the participating systems, devices and applications are linked (federated), and the participating systems, devices and applications accept each other's authentication of the user. Possibly, each user may have one username and one password for all of the systems, devices, and applications to which the user has access, and each device, system, and application may query an identity provider for the identity federations, and possibly a centralized database for authentication and authorization information. Hence, in such a system, participating entities may have a contracted mutual trust in each other's authentication of a user.

According to yet another exemplifying embodiment of the present invention, the interaction with the user may be performed via a mobile user-identity communications device. The mobile user-identity communications device may comprise a memory unit adapted to store data, wherein the at least one user pseudonym comprised in the set and at least some of the secrets may be stored in the memory unit.

Such a mobile user-identity communications device may for example be a personal device or a shared device provided with authentication means (for example intended to be used within a family of persons). For example, the second secret may be manually set or generated, e.g. on-the-fly, in the user-identity communications device or may be derived for example by using a combination of biometrics of the person that is using the user-identity communications device and device PUF. By such a mobile user-identity communications device, the user may have easy access to the information, for example the first and second secrets, required in a method according to an embodiment of the present invention such as been described in the foregoing, which may facilitate performing the method.

According to yet another exemplifying embodiment of the present invention, the user and the party may verify their identities to each other by means of a Public Key Infrastructure (PKI) unit.

In this manner, the number of successful so called man-in-the-middle attacks on the communication between the user and the party by an attacker/intruder may be reduced, or so called man-in-the-middle attacks on the communication between the user and the party may be eliminated altogether.

In the context of the present invention, by the term “man-in-the-middle attack” it is meant a form of active eavesdropping in which the attacker makes independent connections with communicating parties, which send messages between each other, and relays messages between the parties, making the parties believe that they are communicating directly with each other over a private connection, when in fact the entire communication may be controlled by the attacker.

According to yet another exemplifying embodiment of the present invention, the communications unit may be further adapted to communicate the result of the verification or verifications to a party other than the user.

In this manner, the party may be either a trusted third party (e.g., a meta-reputation server) or the interaction party itself, e.g. service portal, a transaction partner, etc., with which the user intends to interact with.

In the context of the present invention, by the term “meta-reputation server” it is meant a server, processing unit or the like adapted to manage meta-reputation data associated with one or more users, which users in turn may be associated with one or several service portals. Such a meta-reputation server may e.g. be adapted to collect, aggregate and distribute user reputation data from various service portals.

According to yet another exemplifying embodiment of the present invention, the retrieval of the first and/or second coded strings from the service portal associated with the user pseudonym comprises reading information embedded in content from the service portal, extracting structured data using, e.g., microformats, Resource Description Framework (RDF), FOAF, or Extensible Markup Language (XML), or extracting unstructured data using, e.g., text analysis.

By such a configuration, the process of determining at a party whether a particular set of user pseudonyms is associated with a particular user may be performed such that even less or substantially no action is required by the service portals, but merely some additional (e.g. user-provided) data is required to be embedded in regular web pages (of the service portal). In other words, a minimal amount of interplay between the service portal and the user and/or the party may be required for determining at the party whether a particular set of user pseudonyms is associated with the user. In this manner, the process of exporting the user's local user reputations at other service portals or entities to the party may be considered basically as a user and/or requesting party operation only. Furthermore, by such a configuration, the first and/or second strings does not necessarily have to be comprised in structured data at the service portal.

In the context of the present invention, by the term “microformats” it is meant small patterns of information for representing published information at a service portal, such as small patterns of HyperText Markup Language (HTML) for representing published (i.e. publicly available) information on web pages of the service portal. An advantage of micro-formats is that microformats may provide both a human and device interpretable representation of information. Microformats provide an advantage over text-only data visible to a human by providing structure and hiding data intended for machine interpretation only.

In the context of the present invention, by the term “web pages” it is meant a document or resource of information suitable for the World Wide Web that can be accessed by a web browser application and displayed e.g. on a computer screen.

Further objects and advantages of the present invention will be described below by means of exemplifying embodiments.

The steps of any method disclosed herein do not have to be performed in the exact order disclosed, unless explicitly stated.

It is noted that the invention relates to all possible combinations of features recited in the claims.

### BRIEF DESCRIPTION OF THE DRAWINGS

Exemplifying embodiments of the invention will be described below with reference to the accompanying drawings, in which:

FIGS. 1-4 are schematic views illustrating respective exemplifying embodiments of the present invention;

FIG. 5 is a schematic block diagram of a trust management system according to an exemplifying embodiment of the present invention; and

FIG. 6 is a schematic view illustrating computer readable storage mediums according to exemplifying embodiments of the present invention.

In the accompanying drawings, the same reference numerals denote the same or similar elements throughout the views.

### DESCRIPTION OF EXEMPLIFYING EMBODIMENTS

The following is a description of exemplifying embodiments in accordance with the present invention. It is to be understood that the following description is non-limiting and for the purpose of describing the principles of the present invention.

First of all, for describing the general principles of the present invention, the following exemplifying scenario may be considered, where a user Alice, also denoted by I in the following, which has n user pseudonyms Pᵢ, i=1, 2, 3, . . . , n at n different service portals, wants to prove to or assure a third party Bob (that may be a consumer, a service portal, a service provider, a transaction party, etc.) that the set of user pseudonyms Z={P₁, P₂, P₃, . . . , Pₙ} belongs the user Alice. Furthermore, Alice may also want to prove to or assure Bob that reputation values, or reputation metadata, that are publicly visible (available) at the respective service portals, wherein each reputation value is associated with the reputation of Alice at the respective service portal, indeed belong to the user Alice. For one or more of these purposes, the following exemplifying cryptographic procedure, or protocol, may be performed:

Alice→Bob: transmit the set Z and the respective locations of the service portals associated with each user pseudonym in the set Z.

Service portals→Bob: for each user pseudonym i (i.e. for each service portal), retrieve a coded string Cᵢ=A [symbol] B [symbol] )=(g^{K} [symbol] , g^{U} [symbol] ^{K} [symbol] ) associated with the user pseudonym i at the respective portal, where g is a generator of the multiplicative group modulo N, where N is a prime number (all arithmetic in this example may be performed modulo N), A [symbol] is a first coded string associated with the user pseudonym Pᵢ, and B [symbol] is a second coded string associated with the user I (Alice), K [symbol] is a first secret, on the basis of which the first coded string Aᵢ may be generated, and U_{I} is a second secret associated with the user I, on the basis of which the second coded string Bᵢ may be generated.

Bob→Alice: transmit g^{a}, where a is chosen randomly by Bob.

At Bob: compute H[(g^{K} [symbol] )^{a}]=τz,999 , i=1, 2, 3, . . . , n, where H[ ] is a hash function, for example Secure Hash Algorithm 256 (SHA-256).

At Alice: compute H[((g^{a})^{K} [symbol] ]μᵢ, i=1, 2, 3, n.

Alice→Bob: transmit μ [symbol] , i=1, 2, 3, n.

At Bob: check if τᵢ=μᵢ for all i=1, 2, 3, n. If the check is in the positive, then the user Alice has assured Bob that Alice has knowledge of every first secret K [symbol] K associated with the user pseudonym Pᵢ, i=1, 2, 3, n.

At Bob: compute ω=(Πᵢ₌₁ [symbol] g^{K} [symbol] )^{b} and ρ=H[(Πᵢ₌₁ [symbol] g^{U} [symbol] ^{K} [symbol] )^{b}], where b is chosen randomly by Bob.

Bob→Alice: transmit ω.

At Alice: compute φ=H[ω^{U} [symbol] ].

Alice→Bob: transmit ω.

At Bob: check if φ=ρ. If the check is in the positive, then the user Alice has assured Bob that Alice has knowledge of the second secret U_{I}U associated with the user I (Alice).

Now, if both checks in 7) and 12) are positive, Bob may be assured that the user pseudonyms Pᵢ in the set Z are associated with the user Alice [by 3)-7)] and that the user pseudonyms Pᵢ in the set Z are not shared with (or bought from) other parties [by 8)-12)].

If N and g are chosen to be relatively large, then the above protocol 1)-12) may be shown to be secure based on the hardness of the discrete logarithm problem. N and g may be public. According to the above exemplifying procedure, 3)-7) comprise a protocol based on a Diffie-Hellman protocol (e.g. W. Diffie and M. E. Hellman, IEEE Transactions on Information Theory, vol. IT-22, November 1976, pp. 644-654). Rather than to key-exchange between Alice and Bob, the Diffie-Hellman-based protocol may be adapted to verify that the first secrets K [symbol] , i=1, 2, 3, . . . , n, associated with and unique to each of the user pseudonyms Pᵢ in the set Z are known to the user (in this exemplifying case, Alice).

As already indicated above, for each user pseudonym i (i.e. for each service portal) Bob may retrieve a publicly visible (available) reputation value, or reputation metadata, associated with the user I (Alice), indicative of the service portal's estimation of the user's reputation, for example in interacting with other participating parties at the service portal. As already mentioned above, if both checks in 7) and 12) are positive, Bob may be assured that the user pseudonyms Pᵢ in the set Z are associated with the user Alice [by 3)-7)] and that the user pseudonyms Pᵢ in the set Z are not shared with (or bought from) other parties [by 8)-12)]. The third party Bob may then, on the basis of retrieved reputation metadata, be adapted to derive a trust metric, e.g. by aggregating retrieved reputation metadata from the service portals. The trust metric may be adapted such that it is indicative of the reputation of the user Alice across service portals. The deriving of the trust metric may for example be performed using a set of rules that is specific and/or adapted to Bob. As the specific manner in which the trust metric is created is not critical to the implementation of the present invention as such, detailed description thereof is omitted.

In the following, exemplifying embodiments in accordance with the present invention are described with reference to the appended drawings.

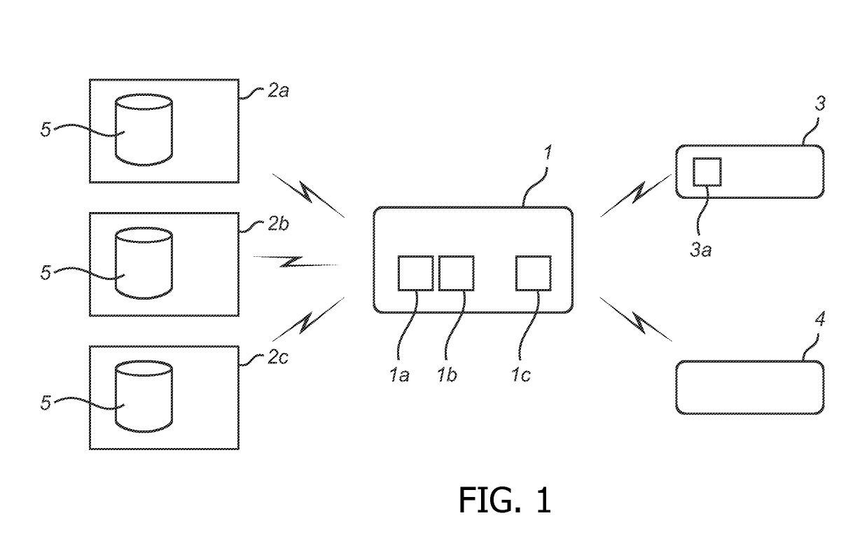

Referring to FIG. 1, there is shown a schematic view illustrating an exemplifying embodiment of the present invention. In FIG. 1 there is shown a device 1 adapted to determine whether a set comprising at least one user pseudonym is associated with a user, wherein each of the user pseudonyms in the set is associated with the user at a service portal 2a, 2b, 2c. Each of the service portals 2a, 2b, 2c may further comprise a storage unit 5 adapted to store data, such as information relating to user pseudonyms of users at the respective service portal 2a, 2b, 2c and user reputation metadata, i.e. information indicative of the reputation of users at the service portals 2a, 2b, 2c, for example with regards to interaction with other parties at the respective service portal. Although only three service portals 2a, 2b, 2c are depicted in FIG. 1, the present invention is not limited to three service portals 2a, 2b, 2c only, but rather encompasses embodiments wherein the number of service portals 2a, 2b, 2c is arbitrary, for example one, two, four, five, six, eight or ten or more service portals. In view of the above, according to the exemplifying embodiment of the present invention depicted in FIG. 1, the set of user pseudonyms may for example comprise three user pseudonyms, each of the three user pseudonyms being associated with the user at the service portal referenced by the items 2a, 2b and 2c, respectively.

Referring further to FIG. 1, the device 1 may comprise a communications unit 1a adapted to perform wireless communication of signals (information) from the device 1 to other devices adapted to perform wireless communication and/or in a wireless fashion receive signals (information) from other devices adapted to perform wireless communication. The device 1 may further comprise a processing unit 1b adapted to process information, e.g. signals received by the device 1, in various manners such as have been described in the foregoing and further described in the following description.

With further reference to FIG. 1, the device 1 may be adapted to communicate with a mobile user-identity communications device 3 comprising a memory unit 3a adapted to store data, wherein the device 1 may interact with a user via the mobile user-identity communications device 3, and wherein the user pseudonyms of the user, comprised in the set, and the first and/or second secrets may be stored in the memory unit 3a. Thus, the mobile user-identity communications device 3 may be associated with or operated by the user. According to the embodiment of the present invention depicted in FIG. 1, the device 1 may be adapted to communicate the result of the verifications, such as been described in the foregoing, performed in the process of determining whether the set comprising the user pseudonym is associated with the user, to a mobile user-identity communications device 4 other than the mobile user-identity communications device 3 associated with or operated by the user. The mobile user-identity communications device 4 may be associated with or operated by a party, e.g. service portal, a transaction partner, etc., with which the user intends to interact with and to which the user wants to prove or assure that the user pseudonyms in the set indeed are associated with the user. In this manner, the device 1 does not have to be, or be associated with, the interaction party itself, but the device 1 may for example be a trusted third party, for instance a meta-reputation server adapted to perform a method according to an embodiment the present invention, in order to assure or prove to an interaction party that a set of user pseudonyms indeed is associated with a particular user. Then, in case the interaction party is assured that the set of user pseudonyms indeed is associated with the user, the interaction party (e.g. a meta-reputation server) may process reputation metadata associated with the respective user pseudonyms, retrieved from the respective service portals, in order to obtain an indication of the reputation of the user with regards to interaction with other parties. For instance, a trust metric associated with the user may be derived on the basis of the retrieved reputation metadata.

With further reference to FIG. 1, the device 1 may comprise a Public Key Infrastructure (PKI) unit 1c. The PKI unit 1c may enable the user associated with the mobile user-identity communications unit 3 and the party associated with the mobile user-identity communications unit 4 to verify their identities to each other. In this manner, so called man-in-the-middle attacks may be mitigated or eliminated.

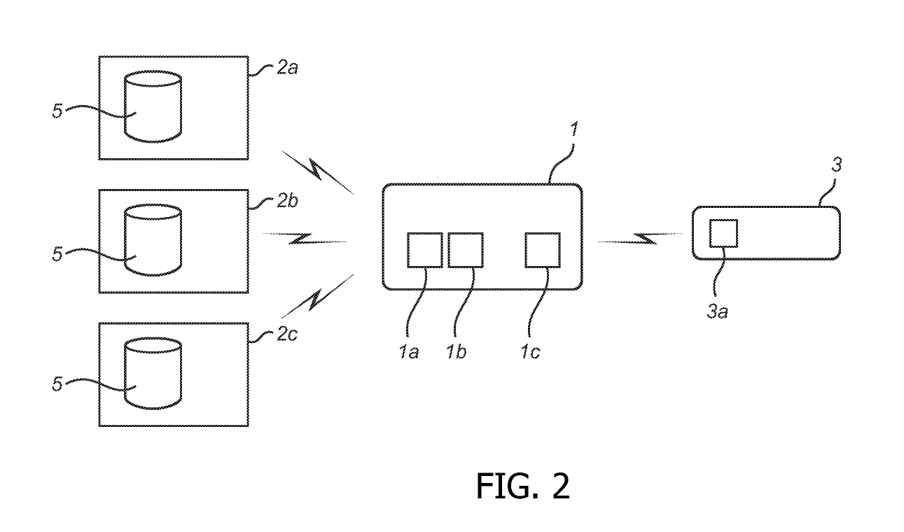

Referring now to FIG. 2, there is shown a schematic view illustrating another exemplifying embodiment of the present invention. FIG. 2 shows elements and/or components similar to or the same as elements and components shown in FIG. 1. The description of such similar or identical elements and components with reference to FIG. 2 is therefore omitted. With reference to FIG. 2, in contrast to the exemplifying embodiment of the present invention described with reference to FIG. 1, the device 1 may be, or be associated with, the interaction party itself.

With further reference to FIG. 2, the device 1 may comprise a Public Key Infrastructure (PKI) unit 1c. The PKI unit 1c may enable the user associated with the mobile user-identity communications unit 3 and device 1 to verify their identities to each other. In this manner, so called man-in-the-middle attacks may be mitigated or eliminated.

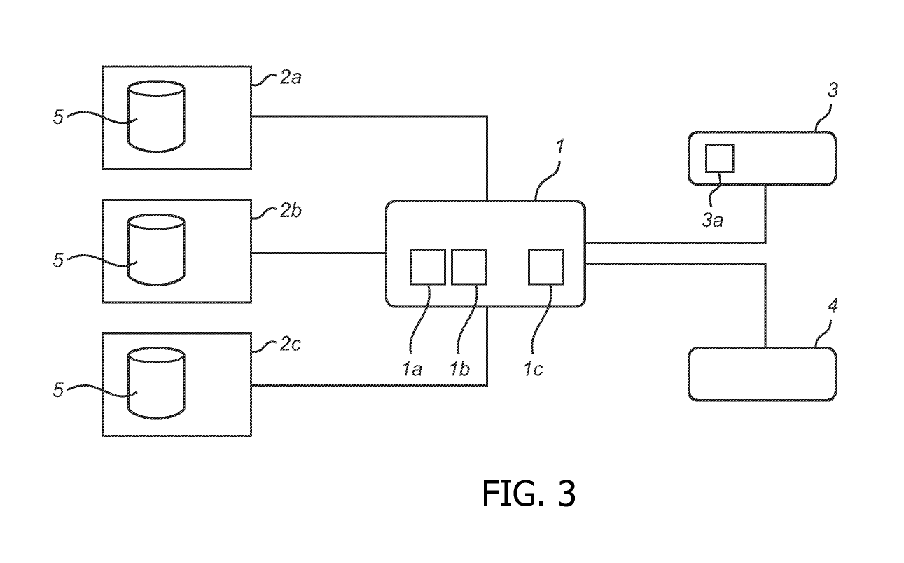

Referring now to FIG. 3, there is shown a schematic view illustrating yet another exemplifying embodiment of the present invention. FIG. 3 shows elements and/or components similar to or the same as elements and components shown in FIG. 1. The description of such similar or identical elements and components with reference to FIG. 3 is therefore omitted. With reference to FIG. 3, in contrast to the exemplifying embodiment of the present invention described with reference to FIG. 1, the elements 1, 2a, 2b, 2c, 3, 4 are adapted to communicate signals to each other via communication wires (or lines).

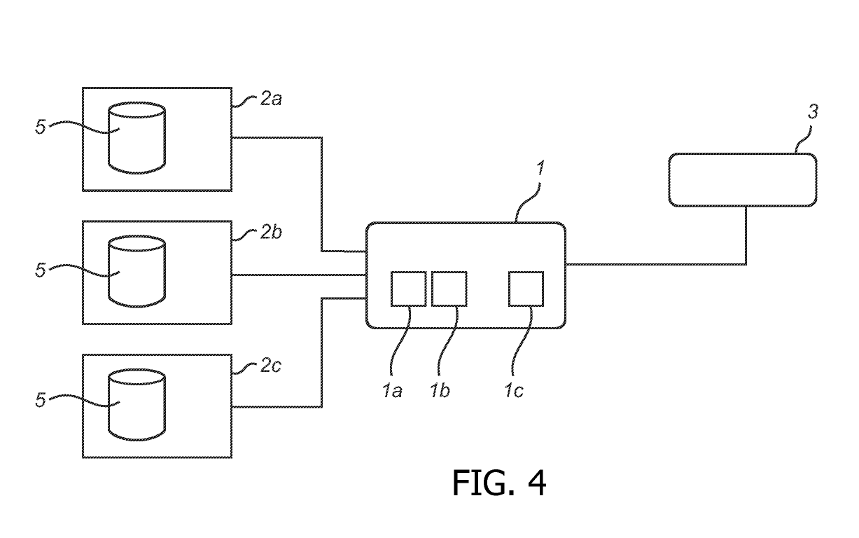

Referring now to FIG. 4, there is shown a schematic view illustrating still another exemplifying embodiment of the present invention. FIG. 4 shows elements and/or components similar to or the same as elements and components shown in FIG. 2. The description of such similar or identical elements and components with reference to FIG. 4 is therefore omitted. With reference to FIG. 4, in contrast to the exemplifying embodiment of the present invention described with reference to FIG. 2, the elements 1, 2a, 2b, 2c, 3 are adapted to communicate signals to each other via communication wires.

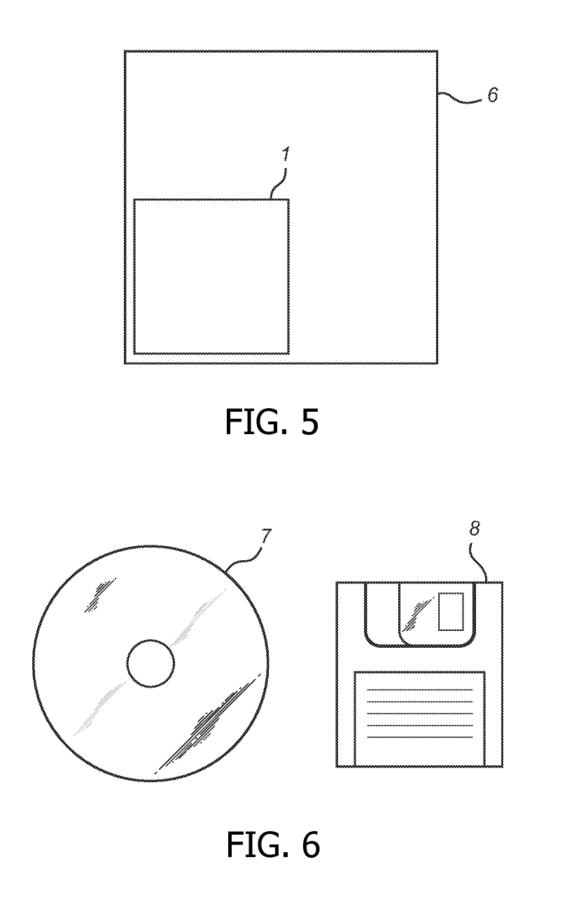

Referring now to FIG. 5, there is shown a schematic block diagram of a trust management system 6 according to an exemplifying embodiment of the present invention, which may be adapted to manage reputation data for at least one user from one or several service portals. As illustrated in FIG. 5, the trust management system 6 may comprise a device 1 adapted to derive a trust metric associated with the at least one user indicative of the at least one user's reputation with regards to interaction with other parties. The device 1 may be adapted to make information based on the trust metric available to a party, for instance a party with which the at least one user is going or intends to interact with.

Referring now to FIG. 6, there is shown a schematic view of computer readable digital storage mediums 7, 8 according to exemplifying embodiments of the present invention, comprising a DVD 7 and a floppy disk 8 on each of which there may be stored a computer program comprising computer code adapted to, when executed in a processor unit, perform a method according to the present invention or embodiments thereof, as has been described in the foregoing.

Although only two different types of computer-readable digital storage mediums have been described above with reference to FIG. 6, the present invention encompasses embodiments employing any other suitable type of computer-readable storage medium, such as, but not limited to, a hard disk drive, a CD, a flash memory, magnetic tape, a USB stick, a Zip drive, etc.

In conclusion, the present invention relates to a method and a device adapted to determine at a party whether a set comprising at least one user pseudonym is associated with a user, wherein each of the user pseudonyms in the set is associated with the user at a service portal. At the party, for each of the user pseudonyms comprised in the set, a publicly available first coded string associated with the user pseudonym is retrieved from the service portal associated with the user pseudonym, wherein each of the first coded strings has been generated on the basis of a first secret unique to said first coded string. The user's knowledge of the first secrets associated with the respective first coded strings is verified by means of a first cryptographic protocol for interacting with the user, wherein the first protocol is adapted to utilize the first coded strings.

Although exemplary embodiments of the present invention have been described herein, it should be apparent to those having ordinary skill in the art that a number of changes, modifications or alterations to the invention as described herein may be made. Thus, the above description of the invention and the accompanying drawings are to be regarded as non-limiting examples of the invention and the scope of protection is defined by the appended claims. Any reference signs in the claims should not be construed as limiting the scope.

1. A method adapted to determine at a party whether a set comprising at least one user pseudonym is associated with a user at the party, wherein each of the user pseudonyms in said set is associated with said user at a service portal (2a, 2b, 2c), the method comprising, at the party:
for each of the user pseudonyms in said set, retrieving from the service portal (2a, 2b, 2c) associated with said user pseudonym a publicly available first coded string associated with said user pseudonym, wherein each of the first coded strings has been generated on the basis of a first secret unique to said first coded string;
verifying that the first secrets associated with the respective first coded strings are known to the user by means of a first cryptographic protocol for interacting with the user, said first protocol being adapted to utilize said first coded strings.

2. The method according to claim 1, further comprising, at the party:
for each of the user pseudonyms in said set, retrieving from the service portal (2a, 2b, 2c) associated with said user pseudonym a publicly available second coded string associated with said user pseudonym, wherein each of the second coded strings has been generated on the basis of a second secret, common to every second coded string; and
verifying that the second secret associated with each second coded string is known to the user by means of a second cryptographic protocol for interacting with the user, said second protocol being adapted to utilize said second coded strings.

3. The method according to claim 1, further comprising:
for each of the user pseudonyms in said set, at the party retrieving from the service portal (2a, 2b, 2c) associated with said user pseudonym reputation metadata, adapted to indicate the service portal's estimation of the user's reputation; and
if the verification is successful, on the basis of retrieved reputation metadata, deriving a trust metric associated with said user, the trust metric being adapted such that said trust metric is indicative of the reputation of said user across service portals.

4. The method according to claim 1, wherein the verification that the first secrets associated with the respective first coded strings are known to the user comprises, at the party:
individually verifying that each of the first secrets associated with the respective first coded strings is known to the user; or
verifying that a result of a cryptographic operation performed on the first secrets associated with the respective first coded strings is known to the user.

5. The method according to claim 2, wherein said second secret comprises a composite number.

6. The method according to claim 1, wherein the first protocol comprises a protocol based on a Diffie-Hellman protocol, adapted to verify that the first secrets associated with the respective first coded strings are known to the user.

7. The method according to claim 1, wherein at least one of the coded strings is adapted such that said at least one of the coded strings is modifiable at the respective service portal (2a, 2b, 2c) only by the user.

8. The method according to claim 1, wherein the interaction with the user is performed via a mobile user-identity communications device (3) comprising a memory unit (3a) adapted to store data, wherein the at least one user pseudonym comprised in said set and at least some of the secrets are stored in said memory unit.

9. A device (1) adapted to determine whether a set comprising at least one user pseudonym is associated with a user, wherein each of the user pseudonyms in said set is associated with said user at a service portal (2a, 2b, 2c), said device comprising:
a communications unit (1a); and
a processing unit (1b);
wherein the communications unit (1a) is adapted to, for each of the user pseudonyms in said set, retrieve from the service portal (2a, 2b, 2c) associated with said user pseudonym a publicly available first coded string associated with said user pseudonym, wherein each of the first coded strings has been generated on the basis of a first secret unique to said first coded string;
wherein the processing unit (1b) is adapted to verify that the first secrets associated with the respective first coded strings are known to the user by means of a first cryptographic protocol for interacting with the user, said first protocol being adapted to utilize said first coded strings.

10. The device according to claim 9, wherein said communications unit (1a) is further adapted to, for each of the user pseudonyms in said set, retrieve from the service portal (2a, 2b, 2c) associated with said user pseudonym a publicly available second coded string associated with said user pseudonym, wherein each of the second coded strings has been generated on the basis of a second secret, common to every second coded string, and wherein said processing unit (1b) is further adapted to verify that the second secret associated with each second coded string is known to the user by means of a second cryptographic protocol for interacting with the user, said second protocol being adapted to utilize said second coded strings.

11. The device according to claim 9, wherein the communications unit (1a) is further adapted to communicate the result of the verification to a party other than the user.

12. The device according to claim 9, further comprising:
a Public Key Infrastructure, PKI, unit (1c) adapted to verify the identities of said party and said user to each other.

13. The device according to claim 9, wherein the communications unit (1a) is further adapted to, for each of the user pseudonyms in said set, retrieve from the service portal (2a, 2b, 2c) associated with said user pseudonym reputation metadata adapted to indicate the service portal's estimation of the user's reputation, and the processing unit (1b) is further adapted to, if the verification is successful, on the basis of retrieved reputation metadata, derive a trust metric associated with said user, the trust metric being adapted such that said trust metric is indicative of the reputation of said user across service portals.

14. A mobile user-identity communications device (3, 4) comprising a memory unit (3a) adapted to store data, wherein said mobile user-identity communications device is adapted to be utilized in a method according to claim 8.

15. A computer program product adapted to, when executed in a processor unit, perform a method according to claim 1.

16. A computer-readable storage medium (7, 8) on which there is stored a computer program product adapted to, when executed in a processor unit, perform a method according to claim 1.

17. A trust management system (6) adapted to manage reputation data for at least one user from one or several service portals (2a, 2b, 2c), wherein said trust management system comprises a device (1) according to claim 13, adapted to derive trust metric associated with said at least one user, said trust management system being further adapted to make information based on said trust metric available to a party.
